(19) United States
(12) Patent Application Publication
(10) Pub. No.: US 2019/0322827 A1
(43) Pub. Date: Oct. 24, 2019

(54) PRIMER COATING FOR FIBER FILLED PLASTIC SUBSTRATE

(71) Applicant: Magna Exteriors Inc., Concord (CA)

(72) Inventors: Benjamin J. Barber, Rochester, MI (US); Ganesh Singh, Troy, MI (US); Alexis Baltazar y Jimenez, Concord (CA)

(73) Assignee: Magna Exteriors Inc., Concord (CA)

(21) Appl. No.: 16/456,600

(22) Filed: Jun. 28, 2019

Related U.S. Application Data
(63) Continuation-in-part of application No. PCT/IB2018/055649, filed on Jul. 27, 2018.
(60) Provisional application No. 62/537,759, filed on Jul. 27, 2017.

(51) Int. Cl. C08J 7/04

(52) U.S. Cl. CPC C08J 7/047; B62D 29/04

(57) ABSTRACT

A method for producing a Class “A” paintable surface on a fiber filled substrate part: the method provides a fiber filled polymer part having an outer show surface for use on a vehicle. This part is coated with a flexible primer coating substantially free of pigments for forming a primed surface capable of being painted for forming a Class “A” show surface for a vehicle.

### FIELD OF THE INVENTION

The present invention relates to a primer coating for fiber filled plastic substrates used in an exterior show surface of a vehicle.

### BACKGROUND OF THE INVENTION

Painting of polymer Class “A” surfaces in automobile manufacturing is a complex endeavor even under the best of circumstances. Typically it has not been possible to use glass fiber filled structural polymers to provide exterior Class “A” finished surface parts. In many cases an outer shell of metal or polymer is designed to cover a structural substrate part in order to achieve a final Class “A” surface. Removing this necessity and providing a way to provide a Class “A” surface on a structural glass fiber filled polymer part would reduce weight and cost. Therefore it is a goal to achieve a Class “A” automotive paint finish on a fiber filled substrate part.

Fiber filled thermoformed compositions are increasingly more common in manufacture of vehicle body panels, lift gates, hoods, and other vehicle parts. In many cases these parts are lighter than their steel counter parts and therefore offer a weight advantage. Often fiber filled substrates are manufactured as structural back panels or sub frames and it is necessary to provide an outer paintable Class “A” show surface over the underlying fiber filled structural substrate. This is because there has not been a useable and/or cost effective way to provide a Class “A” finish on these parts.

Thus, typically fiber filled substrates are the structural part of a vehicle body panel or the like with an outer show surface skin. Therefore, extra time and other processes are required for manufacture and bonding of the two pieces together. Typically, surfaces of the fiber filled materials have not been found suitable for painting and forming a Class “A” exterior surface of a vehicle.

Therefore, manufacturing labor and other costs can be saved if it were possible to provide a paint and process for allowing painting and forming a Class “A” surface on a finished part where the part includes an exterior show surface of a vehicle.

In the past when attempts at painting fiber filled parts using conventional coating (primer materials) cannot achieve a SW (short wave) that meets automotive specifications. SW is a quantitative measurement of an automotive vehicle surface determined using a wave scan device. The wave scan device determines the spectrum of reflected light from the painted surface and shows the amount of long wave and short wave light being reflected. The more shortwave or SW as used herein, the less desirable the part looks. During measurement light of different wavelengths (e.g, 16 μm to 50 μm is directed to the part surface. The reflected light has different wave lengths which are plotted based on intensity. Ideally the LW and SW values will be the same or close in intensity. However, with fiber reinforced resin components the SW value has been too high. The present invention seeks to address the problem of having too high of an SW value by providing a fiber filled polymer composition and flexible primer that reduces the SW value when the part is painted. The coatings were found to contain a SW which was poor to hazy in appearance and not suitable for a Class “A” show surface of a vehicle.

Thus a goal of the present invention is to provide a painting system for a fiber filled substrate that allows a Class “A” show surface on the final part.

No available paint primers within current technology are known to solve this problem.

### SUMMARY OF THE INVENTION

In accordance with the above goals and objectives, a method for producing a Class “A” painted surface on a fiber filled substrate vehicle part is provided. The method includes the steps of:
a. Providing a fiber filled polymer part having an outer show surface for use on a vehicle.
b. Coating said molded outer surface with a flexible primer coating substantially free of pigments for forming a primed surface capable of being painted for forming a Class “A” show surface for a vehicle.

A primer for providing a primed fiber filled substrate vehicle part with a Class “A” paintable surface is also provided wherein the primer is a flexible coating on the fiber filled substrate which includes from about 70 to 100% by weight of a first cross-linkable resin selected from the group of polyurethane, polyester, melamine, and acrylic resins and mixtures thereof and from about 1 to about 30% of a second compatible cross-linkable isocyanate resin preferably a monomeric urethane isocyanate resin.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE PREFERRED EMBODIMENTS

The following description of the preferred embodiment(s) is merely exemplary in nature and is in no way intended to limit the invention, its application, or uses.

In its broad aspects the present invention uses an unpigmented flexible primer which improves the appearance of the final Class “A” surface of a show surface of a part made from a fiber filled polymer material. The primer flexibility maintains a Class “A” show surface of SW less than 50 to provide a suitable show surface even during thermal expansion and contraction of the substrate.

In accordance with the present invention there is provided a method for producing a Class “A” paintable surface on a fiber filled substrate vehicle part. The method includes:
a. Providing a fiber filled polymer part having an outer show surface for use on a vehicle.
b. Coating said molded outer surface with a flexible primer coating substantially free of pigments for forming a primed surface capable of being painted for forming a Class “A” show surface for a vehicle.

A primer for providing a primed fiber filled substrate vehicle part with a Class “A” paintable surface is also provided wherein the primer is a flexible coating on the fiber filled substrate which includes from about 70 to 100% by weight of a first cross-linkable resin selected from the group of polyurethane, polyester, melamine, and acrylic resins and mixtures thereof and from about 1 to about 30% of a second compatible cross-linkable isocyanate resin preferably a monomeric urethane isocyanate resin.

The substrates useful in the present invention typically include fiber filled polymer materials normally used as structural parts in vehicle body panel. One such material is a sheet molding composition substantially filled with between 1″ and 3″ glass fibers. Other materials in which the invention is useful include thermoplastic olefins substantially filled with chopped carbon and/or long glass fibers and molded into a final part which includes a Class “A” surface as a part of the final molded part molded out of the fiber filled material. Other chopped carbon fiber filled thermoset or thermoformed polymer parts will find the present invention advantageous. For instance, the primers of the present invention are also useful on carbon fiber filled materials. Such filled carbon fiber materials include 35% to 65% by weight sheet molding composition and 35% to 65% by weight 0.5″ to 2.5″ carbon fibers.

When substrates of polyamide and polyolefin thermoplastic resins with fiber reinforcements are used it can hinder achieving a class “A” finish (determined by unfavorable SW values). The reason for this is that there is a difference in the thermal conductivity and fiber alignment between fiber-rich and resin-rich micro-domains that form in the substrate. This invention addresses this problem by providing an additional embodiment of the invention where the substrate is a thermoplastic matrix with fiber reinforcements. In this embodiment the thermoplastic matrix with fiber reinforcements is formed of at least two resins of the group including polyamide, polypropylene, acrylonitrile butadiene styrene and various combinations thereof, in addition to fiber reinforcements that are glass fibers or carbon fibers.

In a preferred embodiment the flexible primer comprises a clear melamine primer layer. Flexible primers made in accordance with the present invention must be capable of having the ability to build up a film to a 50 micron thickness without sagging while maintaining the SW of generally less than 50, typically less than 35 and in preferably less than 15.

In a further preferred embodiment flexible primer coating is a two component high solids leveling primer material which includes generally from about 70 to 100% by weight of a first cross-linkable resin selected from the group of polyurethane, polyester, melamine, and acrylic resins and mixtures thereof and from about 1 to about 30% by weight of a second compatible cross-linkable isocyanate resin preferably a monomeric urethane isocyanate resin. A material meeting the criteria of the present invention is an SX 1056 flexible 2K sealer and SX 1058 2K primer catalyst available from PPG Automotive Resins mixed in the above ratios.

Preferably the first component is a high solids material containing greater than 50% solids and has a sag control agent in an amount of 8 to about 12% by weight. Preferably the sag control agent is a polyurea having fine crystalline needles in its structure.

In order to ensure the necessary flexibility of the final component it is necessary to make sure that the components selected for the first and second components of the coating are substantially free of any pigmented fillers which would decrease or otherwise detrimentally affect flexibility.

Further information concerning the invention will be realized in view of the examples below with reference to the specification and claims herein.

### Example 1

Test panels were prepared in accordance with the chart in Table 1 using the Urethane SX 1056 primer and SX 1058 catalyst in a 4 to 1 ratio by weight. A primer coat was applied over a glass filled SMC surface. After curing for 30 minutes at 80 degrees centigrade, urethane based automotive base coats and top coats are applied over the primed surface and then cured in accordance with Table 1. As shown in the chart the SW results are greater than 15 with the first test panel being 43.2 and the second test panel being 25.

TABLE 1

| | | | Base | Clear | Clear | | 240 hr | | Horz Appearance | | | |
|---|---|---|---|---|---|---|---|---|---|---|---|---|
| | Primer | Primer | Coat | Coat | Coat | Initial | Humdity | Readings | (Spraymation) | | | |
| Panel # | Code | Bake | Code | Code | Bake | Adhesion | Adhesion | Taken | LW | SW | R | DOI |
| 1 | SX1056/1058 | 30/80 C. | urethane | urethane | 30/80 C. | 100% | 100% | Cooled | 8.1 | 43.2 | 7.5 | 86.6 |
| 2 | SX1056/1058 | 30/80 C. | urethane | urethane | 30/80 C. | 100% | 100% | Cooled | 11.5 | 25 | 6.6 | 92.8 |

The values in table one of LW (Long Wave) SW (short wave) and DOI (Distinctiveness of Image) are measured using a BYK-Wave Scan instrument available from BYK Gardner USA 9104 Guilford Road, Columbia, Md. 21406.

### Example 2

Flexible urethane primers are mixed in with catalyst in amounts of 70, 80, 90 and 99% by weight of a first cross-linkable resin selected from the group of polyurethane, polyester, melamine, and acrylic resins and mixtures thereof and from about 1, 10, 20, and 30% by weight of a second compatible cross-linkable isocyanate resin preferably a monomeric urethane isocyanate resin. Each of these mixtures are used with a sag control agent in weights of 8, 9, 10, 11 and 12 percent by weight in the first component. These primers are applied to various thermoplastic fiber filled substrates in coatings of up to about 50 microns and cured. Thereafter standard urethane base automotive grade base coats and top coats are applied and are allowed to cure. The panels are tested for SW and all are found to be less than 50 with some samples being less than 35 and some are less than 20% with one less than 15.

### Example 3

Flexible urethane primers are mixed in with catalyst in amounts of 70, 80, 90 and 99% by weight of a first cross-linkable resin selected from the group of polyurethane, polyester, melamine, and acrylic resins and mixtures thereof and from about 1, 10, 20, and 30% by weight of a second compatible cross-linkable isocyanate resin preferably a monomeric urethane isocyanate resin. Each of these mixtures are used with a sag control agent in weights of 8, 9, 10, 11 and 12 percent by weight in the first component. These primers are applied to a fiber filled polymer part formed of a thermoplastic matrix. The thermoplastic matrix includes fiber reinforcements dispersed in a thermoplastic resin that consists essentially of one of the following groups: polyamide, polypropylene, acrylonitrile butadiene styrene. The fiber reinforcements used are glass fibers or carbon fibers that are dispersed in the thermoplastic resin. After application of the flexible urethane primers standard urethane base automotive grade base coats and top coats are applied and are allowed to cure. The panels are tested for SW and all are found to be less than 50 with some samples being less than 35 and some are less than 20% with one less than 15.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A method for producing a Class “A” paintable surface on a fiber filled substrate part comprising:
a. Providing a fiber filled polymer part having an outer show surface for use on a vehicle, wherein the fiber filled polymer part is formed of a thermoplastic matrix wherein the thermoplastic matrix includes fiber reinforcements dispersed in a thermoplastic resin that consists essentially of one of the following groups: polyamide, polypropylene, acrylonitrile butadiene styrene; and
b. Coating said molded outer surface with a flexible primer coating substantially free of pigments for forming a primed surface capable of being painted for forming a Class “A” show surface for a vehicle.

2. The method for producing a Class “A” paintable surface on a fiber filled substrate part of claim 1 wherein the short wave intensity value of the part is less than or equal to about 50.

3. The method for producing a Class “A” paintable surface on a fiber filled substrate part of claim 1 wherein the fiber filled polymer is a sheet molding composition substantially filled with between 1″ and 3″ fibers.

4. The method for producing a Class “A” paintable surface on a fiber filled substrate part of claim 1 where in the flexible primer comprises a clear melamine primer layer.

5. The method for producing a Class “A” paintable surface on a fiber filled substrate part of claim 1 wherein said flexible primer coating has the ability to build a film to a 50 micron thickness without sagging.

6. The method for producing a Class “A” paintable surface on a fiber filled substrate part of claim 1 wherein said flexible primer coating is a two component high solids leveling primer.

7. The method for producing a Class “A” paintable surface on a fiber filled substrate part of claim 7 wherein said flexible primer further comprises from about 70 to 100% by weight of a first cross-linkable resin selected from the group of polyurethane, polyester, melamine, and acrylic resins and mixtures thereof and from about 1 to about 30% of a second compatible cross-linkable isocyanate resin preferably a monomeric urethane isocyanate resin.

8. The method for producing a Class “A” paintable surface on a fiber filled substrate part of claim 8 wherein said first component is a high solids material containing greater than 50% solids.

9. The method for producing a Class “A” paintable surface on a fiber filled substrate part of claim 9 wherein said first component includes a sag control agent in an amount of from about 8 to about 12%.

10. The method for producing a Class “A” paintable surface on a fiber filled substrate part of claim 9 wherein said sag control agent further comprises a polyurea having fine crystalline needles in its structure.

11. The method for producing a Class “A” paintable surface on a fiber filled substrate part of claim 1 wherein said first and second components are substantially free of any pigmented fillers which would decrease flexibility.

12. The method for producing a Class “A” paintable surface on a fiber filled substrate part of claim 1 wherein the part is coated with a base layer and clear coat layer of an automotive Class “A” surface paint system.

13. The method for producing a Class “A” paintable surface on a fiber filled substrate part of claim 12 wherein the short wave intensity value of the part is less than or equal to about 35.

14. The method for producing a Class “A” paintable surface on a fiber filled substrate part of claim 1 wherein the fiber reinforcements of the thermoplastic matrix include one of glass fibers or carbon fibers.

15. A vehicle part having a Class “A” surface comprising:
a. A fiber filled polymer part molded for having an exposed surface to be used as a Class “A” surface, wherein the fiber filled polymer part is formed of a thermoplastic matrix wherein the thermoplastic matrix includes fiber reinforcements dispersed in a thermoplastic resin that consists essentially of one of the following groups: polyamide, polypropylene, acrylonitrile butadiene styrene; and
b. A flexible primer coating on the surface whereby the coated surface has a short wave intensity value of less than 50.

16. The vehicle part of claim 12 wherein the flexible primer coating comprises from about 70 to 100% by weight of a first cross-linkable resin selected from the group of polyurethane, polyester, melamine, and acrylic resins and mixtures thereof and from about 1 to about 30% of a second compatible cross-linkable isocyanate resin preferably a monomeric urethane isocyanate resin.

17. The vehicle part of claim 12 wherein said flexible primer is a melamine coating.

18. The vehicle part of claim 12 wherein said flexible primer is substantially pigment free.

19. The vehicle part of claim 13 wherein said first component is a high solids material containing greater than 50% solids.

20. The vehicle part of claim 13 wherein said first component includes a sag control agent in an amount of from about 8 to about 12%.

21. The vehicle part of claim 17 wherein said sag control agent further comprises a polyurea having fine crystalline needles in its structure

22. The vehicle part of claim 12 wherein the part is coated with a base layer and clear coat layer of an automotive Class “A” surface paint system.

23. The method for producing a Class “A” paintable surface on a fiber filled substrate part of claim 21 wherein the short wave intensity value of the part is less than or equal to about 35.

24. The method for producing a Class “A” paintable surface on a fiber filled substrate part of claim 15 wherein the fiber reinforcements of the thermoplastic matrix include one of glass fibers or carbon fibers.
